(19) United States
(12) Patent Application Publication
(10) Pub. No.: US 2025/0313169 A1
(43) Pub. Date: Oct. 9, 2025

(54) CONTROL DEVICE FOR VEHICLE AIRBAG

(71) Applicant: TOYOTA JIDOSHA KABUSHIKI KAISHA, Toyota-shi (JP)

(72) Inventors: Hideyuki SAKURAI, Toyota-shi (JP); Mitsuyoshi OHNO, Miyoshi-shi (JP); Katsuya SHIMAZU, Toyota-shi (JP)

(73) Assignee: TOYOTA JIDOSHA KABUSHIKI KAISHA, Toyota-shi (JP)

(21) Appl. No.: 19/005,097

(22) Filed: Dec. 30, 2024

(30) Foreign Application Priority Data
Apr. 8, 2024 (JP) 2024-062121

(51) Int. Cl. B60R 21/015; B60R 21/00; B60R 21/01; B60R 21/0136

(52) U.S. Cl. CPC B60R 21/01554; B60R 21/0136; B60R 2021/0004; B60R 2021/01034

(57) ABSTRACT

At the time of the vehicle front collision, whether to deploy only the front-collision airbag or both the ceiling airbag and the front-collision airbag among the ceiling airbag accommodated above the occupant seated on the seat and the front-collision airbag accommodated in front of the occupant is switched according to the front-rear slide position and the seat back angle of the seat.

### CROSS-REFERENCE TO RELATED APPLICATION

This application claims priority to Japanese Patent Application No. 2024-062121 filed on Apr. 8, 2024, incorporated herein by reference in its entirety.

### BACKGROUND

### 1. Technical Field

The present disclosure relates to a control device for a vehicle airbag.

### 2. Description of Related Art

Japanese Unexamined Patent Application Publication No. 2022-049424 (JP 2022-049424 A) describes a technique of detecting at least one of a position of a vehicle seat and a posture of an occupant using a seat sensor, and adjusting a deployment angle of a roof airbag using an angle adjustment mechanism provided on a roof airbag side based on a detection result of the seat sensor.

### SUMMARY

In JP 2022-049424 A, an airbag other than a ceiling airbag is deployed when the vehicle seat is not in a comfortable posture, and the ceiling airbag is deployed alone when the vehicle seat is in the comfortable posture. When the ceiling airbag is deployed alone, however, a large space exists on the vehicle front side of the deployed ceiling airbag. Therefore, the ceiling airbag cannot be held at a desired position when the occupant is restrained by the ceiling airbag, and there is a possibility that the restraint force for the occupant is insufficient.

The present disclosure has been made in consideration of the above-described facts, and an object thereof is to provide a control device for a vehicle airbag capable of improving occupant restraint performance when a ceiling airbag is deployed.

A first aspect provides a control device for a vehicle airbag, including a control unit that switches between deploying, among a ceiling airbag stored above an occupant seated on a seat and a front-collision airbag stored in front of the occupant, only the front-collision airbag and deploying both the ceiling airbag and the front-collision airbag when a vehicle front collision occurs, according to a front-rear slide position and a seat back angle of the seat.

In the first aspect, both the ceiling airbag and the front-collision airbag are deployed when the ceiling airbag is deployed at the time of a vehicle front collision. Thus, the ceiling airbag is supported by the front-collision airbag and held at a desired position at the time of a vehicle front collision. Accordingly, the occupant restraint performance can be improved when the ceiling airbag is deployed.

According to a second aspect, which depends on the first aspect, the control unit may deploy only the front-collision airbag at a time of the vehicle front collision when the seat back angle is within a first angular range corresponding to a normal riding posture and the front-rear slide position is located within a reference range or on a vehicle front side with respect to the reference range, or when the seat back angle is within a second angular range corresponding to a comfortable posture and the front-rear slide position is located on the vehicle front side with respect to the reference range, and the control unit may deploy both the ceiling airbag and the front-collision airbag at a time of the vehicle front collision when the seat back angle is within the first angular range and the front-rear slide position is located on a vehicle rear side with respect to the reference range, or when the seat back angle is within the second angular range and the front-rear slide position is located within the reference range or on the vehicle rear side with respect to the reference range.

In the second aspect, both the ceiling airbag and the front-collision airbag are deployed at the time of a vehicle front collision when the seat back angle is within an angular range corresponding to the normal riding posture and the front-rear slide position is located on the vehicle rear side with respect to the reference range, or when the seat back angle is within an angular range corresponding to the comfortable posture and the front-rear slide position is located within the reference range or on the vehicle rear side with respect to the reference range, that is, when the posture of the occupant is a posture in which a large space exists on the vehicle front side of the ceiling airbag if the ceiling airbag were deployed alone. Accordingly, the ceiling airbag is supported at a desired position by the front-collision airbag at the time of a vehicle front collision, and thus the occupant restraint performance can be improved when the ceiling airbag is deployed.

In the second aspect, meanwhile, only the front-collision airbag is deployed at the time of a vehicle front collision when the seat back angle is within an angular range corresponding to the normal riding posture and the front-rear slide position is located within the reference range or on the vehicle front side with respect to the reference range, or when the seat back angle is within an angular range corresponding to the comfortable posture and the front-rear slide position is located on the vehicle front side with respect to the reference range, that is, when the posture of the occupant is a posture in which sufficient restraint performance can be obtained even if the front-collision airbag were deployed alone. Accordingly, the ceiling airbag can be deployed only when the deployment of the ceiling airbag is effective for restraining the occupant, as compared with a configuration in which the ceiling airbag is always deployed when the occupant is in the comfortable posture (the configuration described in JP 2022-049424 A).

According to a third aspect, which depends on the second aspect, the control unit may adjust a deployment direction of the ceiling airbag using an actuator capable of changing the deployment direction.

In the third aspect, the deployment direction of the ceiling airbag is adjusted by the actuator capable of changing the deployment direction of the ceiling airbag. Thus, the occupant restraint performance can be further improved when the ceiling airbag is deployed.

According to a fourth aspect, which depends on the third aspect, the control unit may adjust the deployment direction toward the vehicle rear side when the seat back angle is within the second angular range and the front-rear slide position is located within the reference range or on the vehicle rear side with respect to the reference range, as compared with when the seat back angle is within the first angular range and the front-rear slide position is located on the rear side with respect to the reference range.

In the fourth aspect, the deployment direction of the ceiling airbag is adjusted to the vehicle rear side when the seat back angle is within an angular range corresponding to the comfortable posture and the front-rear slide position is located within the reference range or on the vehicle rear side with respect to the reference range. Thus, in the above case, the ceiling airbag can be deployed in a more appropriate direction, and the occupant restraint performance can be further improved.

According to a fifth aspect, which depends on the second aspect, the control unit may deploy the ceiling airbag and deploys the front-collision airbag simultaneously with the ceiling airbag or later than the ceiling airbag at a time of the vehicle front collision when the seat back angle is within the first angular range and the front-rear slide position is located on a vehicle rear side with respect to a first reference range, or when the seat back angle is within the second angular range and the front-rear slide position is located on the vehicle front side with respect to a second reference range different from the first reference range, and the control unit may deploy the front-collision airbag first and the ceiling airbag later at a time of the vehicle front collision when the seat back angle is within the second angular range and the front-rear slide position is located within the second reference range or on the vehicle rear side with respect to the second reference range.

In the fifth aspect, the ceiling airbag is deployed and the front-collision airbag is deployed simultaneously with the ceiling airbag or later than the ceiling airbag at the time of a vehicle front collision when the seat back angle is within an angular range corresponding to the normal riding posture and the front-rear slide position is located on the vehicle rear side with respect to the first reference range, or when the seat back angle is within an angular range corresponding to the comfortable posture and the front-rear slide position is located within the second reference range different from the first reference range. Accordingly, the occupant restraint performance can be improved by supporting the ceiling airbag using the front-collision airbag at the time of a vehicle front collision, as compared with when the ceiling airbag or the front-collision airbag is deployed alone.

In the fifth aspect, meanwhile, the front-collision airbag is deployed first and the ceiling airbag is deployed later at the time of a vehicle front collision when the seat back angle is within an angular range corresponding to the comfortable posture and the front- rear slide position is located within the second reference range or on the vehicle rear side with respect to the second reference range. Accordingly, the ceiling airbag deployed later is guided by the front-collision airbag deployed first at the time of a vehicle front collision, whereby the occupant can be restrained at a more suitable position on the vehicle rear side. In addition, the above-described effects can be obtained only by controlling the deployment order of the airbags, and therefore the structure can be simplified and the cost can be reduced as compared with a configuration in which the deployment range of the ceiling airbag is adjusted.

According to a sixth aspect, which depends on the fifth aspect, the second reference range may be set on the vehicle rear side with respect to the first reference range.

In the sixth aspect, the occupant restraint performance can be further improved by setting two reference ranges (a first reference range and a second reference range on the vehicle rear side with respect to the first reference range) for the front-rear slide position of the seat.

The present disclosure has an effect of improving occupant restraint performance when a ceiling airbag is deployed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram illustrating an airbag control system according to a first embodiment;

FIG. 1B is a schematic diagram illustrating an airbag control system according to a second embodiment;

FIG. 2 is a flowchart illustrating an airbag control process according to the first embodiment;

FIG. 3A is a schematic view illustrating a seat back angle-adjusting range;

FIG. 3B is a schematic view illustrating an adjusting range of a front and rear slide position according to the first embodiment;

FIG. 3C is a schematic view illustrating an adjusting rage of a front and rear slide position according to the second embodiment;

FIG. 4A is an image diagram showing whether the airbags are deployed and the deployment range of the airbags when the seat back angle is within -A and the front and rear sliding positions are within HP-A in the first embodiment;

FIG. 4B is an image diagram showing whether the airbags are deployed and the deployment range of the airbags when the seat back angle is within -A and the front-rear slide position is within HP-B in the first embodiment;

FIG. 4C is an image diagram showing whether the airbags are deployed and the deployment range of the airbags when the seat back angle is within -A and the front-rear slide position is within HP-C in the first embodiment;

FIG. 4D is an image diagram showing whether the airbags are deployed and the deployment range of the airbags when the seat back angle is within -B and the front-rear slide position is within HP-A in the first embodiment;

FIG. 4E is an image diagram showing whether the airbags are deployed and the deployment range of the airbags when the seat back angle is within -B and the front-rear slide position is within HP-B in the first embodiment;

FIG. 4F is an image diagram showing whether the airbags are deployed and the deployment range of the airbags when the seat back angle is within -B and the front-rear slide position is within HP-C in the first embodiment;

FIG. 5 is a flowchart illustrating an airbag control process according to the second embodiment;

FIG. 6A is an image diagram showing whether the airbags are deployed and the deployment range of the airbags when the seat back angle is within -A and the front and rear sliding positions are within HP-A in the second embodiment;

FIG. 6B is an image diagram showing whether the airbags are deployed and the deployment range of the airbags when the seat back angle is within -A and the front and rear slide positions are within HP-B in the second embodiment;

FIG. 6C is an image diagram showing whether the airbags are deployed and the deployment range of the airbags when the seat back angle is within -A and the front and rear slide positions are within HP-C in the second embodiment;

FIG. 6D is an image diagram showing whether the airbags are deployed and the deployment range of the airbags when the seat back angle is within -B and the front and rear slide positions are within HP-A in the second embodiment;

FIG. 6E is an image diagram showing whether the airbags are deployed and the deployment range of the airbags when the seat back angle is within -B and the front and rear slide positions are within HP-B in the second embodiment; and

FIG. 6F is an image diagram showing whether the airbags are deployed and the deployment range of the airbags when the seat back angle is within -B and the front and rear slide positions are within HP-C in the second embodiment.

### DETAILED DESCRIPTION OF EMBODIMENTS

Hereinafter, an example of an embodiment of the present disclosure will be described in detail with reference to the drawings.

### First Embodiment

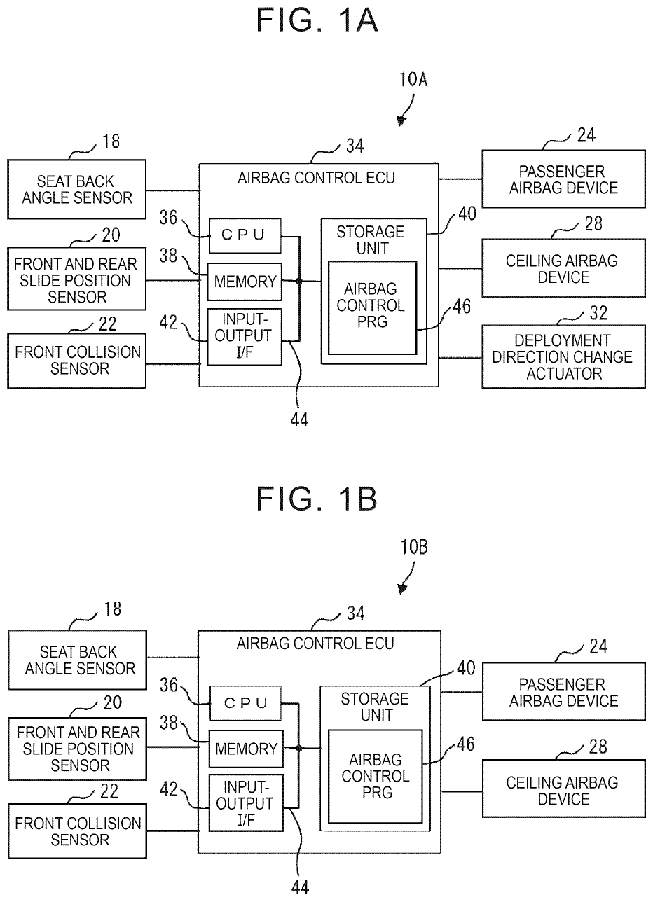

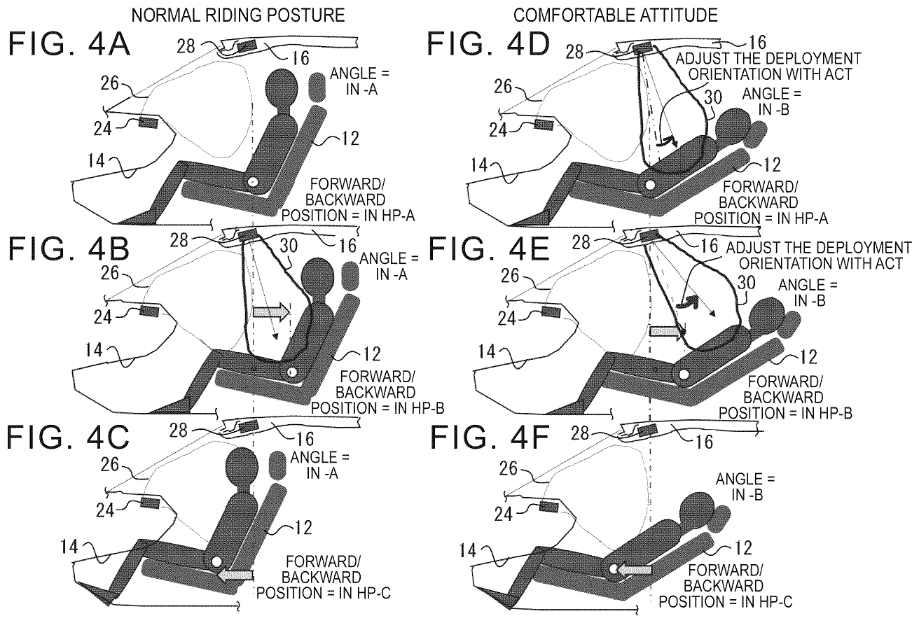

FIG. 1A illustrates an airbag control system 10A according to a first embodiment. In the following description, “airbag” is referred to as “AB”. AB control system 10A is provided corresponding to the passenger seat 12 (hereinafter, simply referred to as “seat 12”) of the vehicle shown in FIGS. 4A to 4F, and is provided with an AB control ECU (Electronic Control Unit) 34. A seat back angle sensor 18, a front and rear slide position sensor 20, a front collision sensor 22, a passenger seat AB device 24, a ceiling AB device 28, and a deployment orientation change ACT (actuator) 32 are connected to AB control ECU 34.

The seat back angle sensor 18 detects an angle of a seat back portion of the seat 12 (hereinafter, simply referred to as a “seat back angle”), and outputs a detection result to AB control ECU 34. The front-rear slide position sensor 20 detects a vehicle-front-rear slide position (hereinafter, simply referred to as a “front-rear slide position”) of the seat 12, and outputs the detected position to AB control ECU 34. The front collision sensor 22 includes an acceleration sensor that detects acceleration in the vehicle front-rear direction, and detects a state in which an acceleration equal to or larger than a predetermined value corresponding to a case where the vehicle collides with an object continues for a predetermined time or longer, as a front collision of the vehicle.

The passenger seat AB device 24 is provided at a position corresponding to the seat 12 in the instrument panel 14 of the vehicle shown in FIGS. 4A to 4F and includes a front collision AB26 (refer to FIG. 4A and the like) formed and stored in a bag shape. The front collision AB26 is supplied with gases from an inflator (not shown) at the time of a vehicle front collision, and is deployed (deployed and expanded) from the instrument panel 14 toward the vehicle rear side. The inflator is a combustion-type or cold-gas-type inflator, which is operated to generate gas. The operation of the inflator is controlled by an AB control ECU 34. The front collision AB26 is an exemplary front-collision airbag according to the present disclosure.

The ceiling AB device 28 is provided at a position corresponding to the seat 12 in the ceiling portion 16 of the vehicle shown in FIGS. 4A to 4F, and includes a ceiling AB30 (refer to FIG. 4B and the like) formed and stored in a bag shape. The ceiling AB30 is supplied with gases from an inflator (not shown) at the time of vehicle front collision, and is deployed (deployed and expanded) from the instrument panel 14 to the vehicle lower side. The inflator is a combustion-type or cold-gas-type inflator, which is operated to generate gas. The operation of the inflator is controlled by the AB control ECU 34. The ceiling AB30 is an exemplary ceiling airbag according to the present disclosure.

The deployment direction changing ACT32 includes a motor such as a stepping motor, and tilts the housing of the ceiling AB device 28 by the driving force of the motor. As a result, the deployment direction changing ACT32 can change and adjust the deployment direction of the ceiling AB30 from the ceiling AB device 28 to the rear of the vehicle, as shown in FIG. 4D and FIG. 4E. Note that the deployment direction changing ACT32 is an exemplary actuator in the present disclosure.

AB control ECU 34 includes a memory 38 such as CPU (Central Processing Unit) 36, ROM (Read Only Memory) and RAM (Random Access Memory), a non-volatile storage unit 40 such as HDD (Hard Disk Drive) and SSD (Solid State Drive), and an input/output I/F (Interface) 42. These are connected to each other via a bus 44. The storage unit 40 stores an AB control program 46. AB control ECU 34 functions as a control unit when AB control program 46 is read from the storage unit 40 and loaded into the memory 38, and AB control program 46 loaded into the memory 38 is executed by CPU 36, and performs an AB control process to be described later. Note that AB control ECU 34 is an exemplary control device for a vehicle airbag according to the present disclosure.

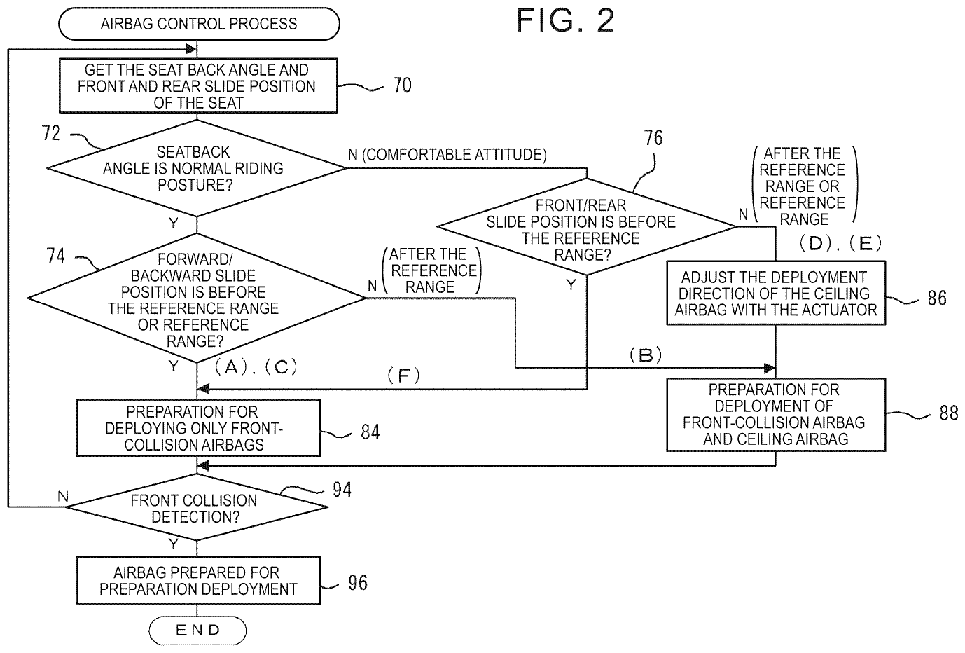

Next, AB control process according to the first embodiment will be described referring to FIG. 2 as an operation of the first embodiment. In step 70 of AB control process, CPU 36 acquires the seat back angle of the seat 12 from the seat back angle sensor 18, and acquires the front and rear slide positions of the seat 12 from the front and rear slide position sensor 20.

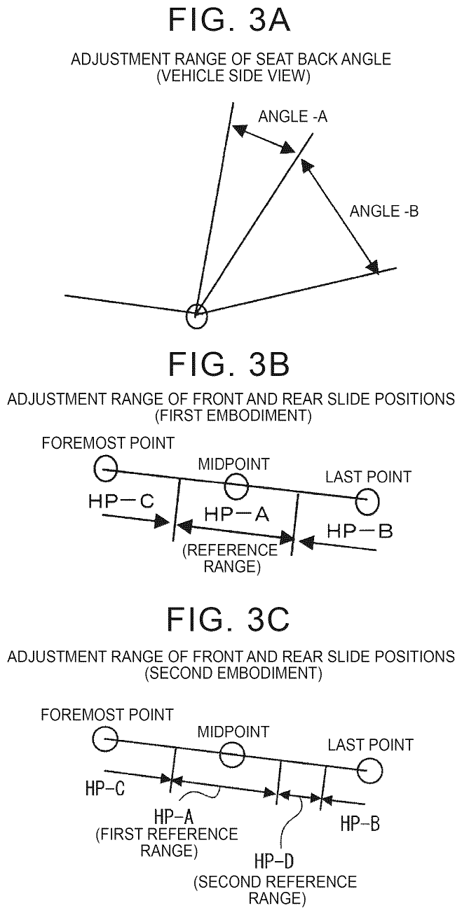

In the present embodiment, as shown in FIG. 3A, the adjustment range of the seatback angle of the seat 12 is divided into an angular range -A in which the seated occupant is in the normal occupant posture and an angular range -B in which the seated occupant is in the comfortable posture. An exemplary angle that is a border between the angular range -A and the angular range -B is 35°. In step 72, CPU 36 determines whether or not the seatback angle obtained in step 70 is within an angular range -A corresponding to the normal riding attitude. If the determination at step 72 is affirmative, the process proceeds to step 74.

In addition, in the first embodiment, as shown in FIG. 3B, the adjustment range of the front-rear slide position of the seat 12 is divided into three ranges: a reference range HP-A including a midpoint of the front-rear slide position, a range HP-B positioned on the vehicle rear side relative to the reference range HP-A, and a range HP-C positioned on the vehicle front side relative to the reference range HP-A. An exemplary reference range HP-A is a range of ±50 mm with respect to the midpoint of the front and rear slide positions. In step 74, CPU 36 determines whether or not the front-rear slide position acquired in step 70 is within the reference range HP-A or the range HP-C ahead of the vehicle from the reference range HP-A.

Here, when the determination in step 74 is affirmative, the seated occupant is in the attitude shown in FIG. 4A or FIG. 4C, and in any case, the seated occupant can be restrained by independently deploying the front collision AB26. Therefore, if the determination in step 74 is affirmative, the process proceeds to step 84, in step 84, CPU 36 performs a preliminary process for developing only the front collision AB26 during the vehicle-front collision, the process proceeds to step 94.

When the determination in step 74 is negative, the front-rear slide position is within the range HP-B on the rear side of the vehicle than the reference range HP-A, and the seated occupant is in the attitude shown in FIG. 4B. In this case, although the ceiling AB30 is suitable for restraining the seated occupant, if the ceiling AB30 is independently deployed, there is a possibility that the restraining force of the occupant is insufficient due to a large space on the vehicle front side of the ceiling AB30 at the time of the vehicle front collision. Therefore, if the determination in step 74 is negative, the process proceeds to step 88, in step 88, CPU 36 performs a preliminary process for deploying the front collision AB26 and the ceiling AB30 at the time of vehicle-front collision, the process proceeds to step 94.

If the seat back angle acquired in step 70 is within the angle range -B corresponding to the comfortable posture, the determination in step 72 is negative, and the process proceeds to step 76. In step 76, CPU 36 determines whether or not the front-rear slide position acquired in step 70 is within the range HP-C ahead of the vehicle than the reference range HP-A. When the determination in step 76 is affirmative, the seated occupant is in the posture shown in FIG. 4F, and in this case, the seated occupant is in the posture in which the seated occupant can be restrained by independently deploying the front collision AB26. Therefore, if the determination in step 76 is affirmative, the process proceeds to step 84, in step 84, CPU 36 performs a preliminary process for deploying only the front collision AB26 during the vehicle-front-collision, the process proceeds to step 94.

When the determination in step 76 is negative, the front-rear slide position is within the reference range HP-A or the range HP-B on the vehicle rear side, and the seated occupant is in the attitude shown in FIG. 4D or FIG. 4E. In this case, although the ceiling AB30 is suitable for restraining the seated occupant, the upper body of the seated occupant is located on the vehicle rear side of the normal deployment range of the ceiling AB30, and it is desirable to change the deployment range of the ceiling AB30 to the vehicle rear side. Therefore, if the determination in step 76 is negative, the process proceeds to step 86, and in step 86, CPU 36 moves the deployment direction of the ceiling AB30 to the vehicle rear side by the deployment direction changing ACT32 (from FIGS. 4A to 4F), see also the “Adjusting the deployment direction by ACT” in FIG. 4E.

Further, when the seated occupant is in the attitude shown in FIG. 4D or FIG. 4E, if the ceiling AB30 is independently deployed at the time of the vehicle front collision, there is a possibility that the restraining force of the occupant is insufficient due to a large space in the vehicle front of the ceiling AB30. Therefore, in the subsequent step 88, CPU 36 performs a preliminary process for deploying each of the front collision AB26 and the ceiling AB30 at the time of the front-collision of the vehicle, and the process proceeds to step 94.

In step 94, CPU 36 determines whether the front collision of the vehicle is detected by the front collision sensor 22. If the determination in step 94 is negative, the process returns to step 70, and steps 70 to 94 are repeated until the determination in step 94 is affirmative. When the front collision of the vehicle is detected by the front collision sensor 22, the determination in step 94 is affirmative, and the process proceeds to step 96, and in step 96, CPU 36 develops AB prepared for development in the preparation process in step 84 or step 88, and ends AB control process.

As described above, in the first embodiment, whether to deploy only the front collision AB26 or both the ceiling AB30 and the front collision AB26 among the ceiling AB30 stored above the occupant seated on the seat 12 and the front collision AB26 stored in front of the occupant at the time of the vehicle front-collision is switched according to the front-rear slide position and the seat-back angle of the seat 12. Accordingly, the occupant restraint performance when the ceiling AB30 is deployed can be improved.

Further, in the first embodiment, when the seatback angle is located within the first angular range -A corresponding to the normal boarding posture and the front-rear slide position is located within the reference range HP-A or closer to the vehicle front side than the reference range HP-A, or when the seatback angle is located within the second angular range -B corresponding to the easy posture and the front-rear slide position is located closer to the vehicle front side than the reference range HP-A, only the front collision AB26 is deployed at the time of the vehicle front-collision, and when the seatback angle is located within the first angular range -A and the front-rear slide position is located behind the vehicle than the reference range HP-A, or when the seatback angle is located within the second angular range -B and the front-rear slide position is located within the reference range HP-A or closer to the vehicle rear side than the reference range HP-A, both the ceiling AB30 and the front collision AB26 are deployed at the time of the vehicle front-collision. Accordingly, the occupant restraint performance when the ceiling AB30 is deployed can be improved, and the ceiling AB30 can be deployed only when the deployment of the ceiling AB30 is valid for the occupant restraint, as compared with a configuration in which the ceiling AB30 is deployed uniformly when the occupant is in the comfortable posture.

Further, in the first embodiment, the occupant restraint performance when the ceiling AB30 is deployed can be further improved because the deployment direction of the ceiling AB30 is adjusted by the deployment direction changing ACT32 capable of changing the deployment direction of the ceiling AB30.

Further, in the first embodiment, when the seatback angle is within the second angular range -B and the front-rear slide position is located within the reference range HP-A or closer to the vehicle rear side than the reference range HP-A, the deployment direction of the ceiling AB30 is adjusted to the vehicle rear side as compared with the case where the seatback angle is within the first angular range -A and the front-rear slide position is located closer to the rear side than the reference range HP-A. As a result, the ceiling AB30 can be deployed more appropriately, and the occupant restraint performance can be further improved.

### Second Embodiment

Next, a second embodiment of the present disclosure will be described. The same parts as those in the first embodiment are designated by the same reference signs, and the description thereof will be omitted. As shown in FIG. 1B, AB control system 10B according to the second embodiment is different from AB control system 10A described in the first embodiment in that the deployment direction changing ACT32 is omitted.

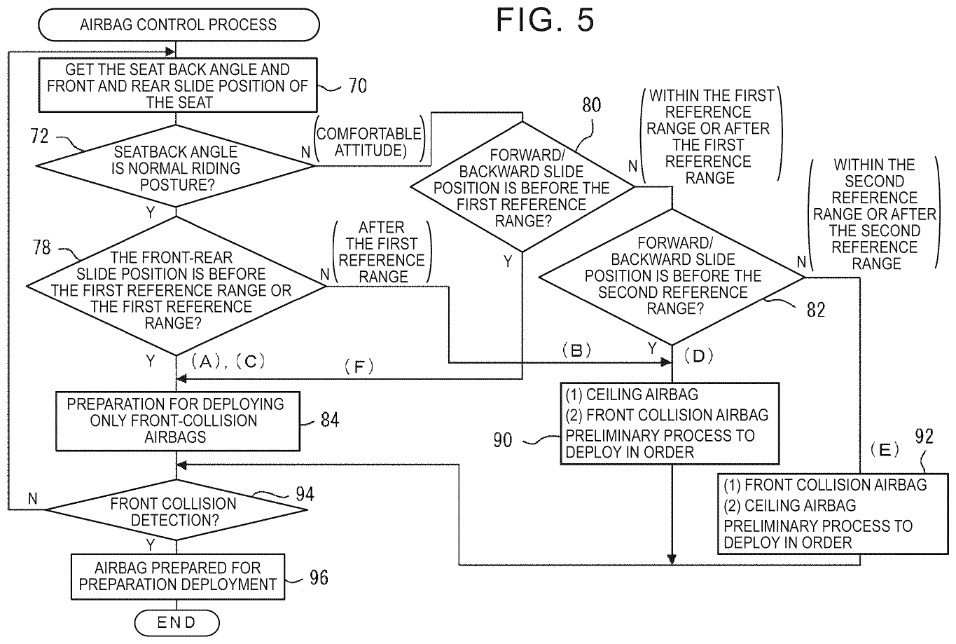

Next, referring to FIG. 5, AB control process according to the second embodiment will be described only differently from AB control process (FIG. 2) described in the first embodiment. In the second embodiment, as shown in FIG. 3C, the range of the front-rear slide position of the seat 12 is divided into four ranges: a first reference range HP-A including a midpoint of the front-rear slide position; a range HP-B positioned on the vehicle rear side rather than the reference range HP-A; a second reference range HP-D positioned between the first reference range HP-A and the range HP-B; and a range HP-C positioned on the vehicle front side relative to the first reference range HP-A.

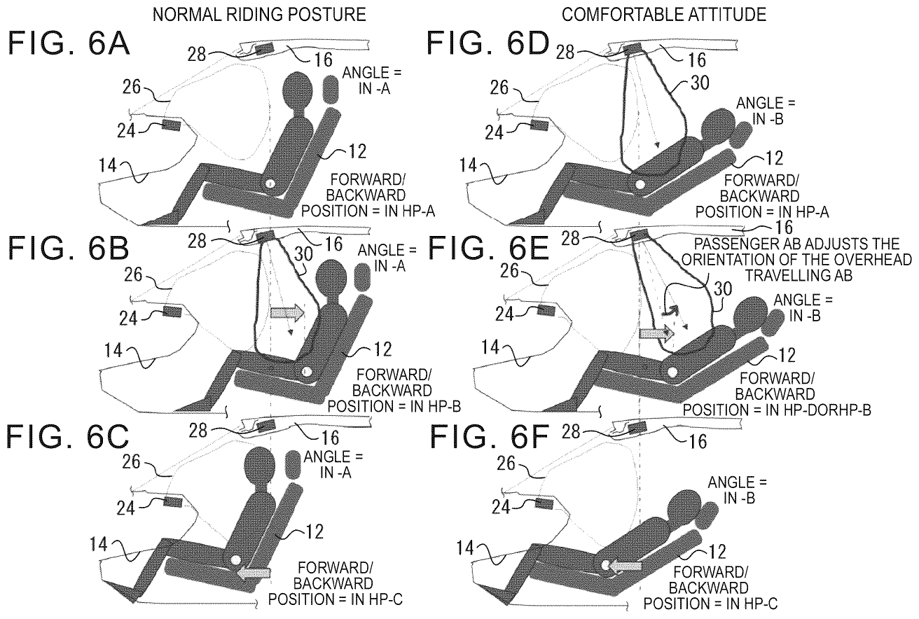

In the second embodiment, if the determination in step 72 is affirmative, the process proceeds to step 78. Then, in step 78, CPU 36 determines whether the front-rear slide position acquired in step 70 is within the range of the first reference range HP-A or within the range HP-C of the vehicle front side from the first reference range HP-A. When the determination in step 78 is affirmative, the seated occupant is in the attitude shown in FIG. 6A or FIG. 6C, and in any case, the seated occupant can be restrained by independently deploying the front collision AB26. For this reason, if the determination in step 78 is affirmative, the process proceeds to step 84, in step 84, CPU 36 performs a preliminary process for deploying only the front collision AB26 during the vehicle-front collision, the process proceeds to step 94.

If the determination in step 72 is negative, the process proceeds to step 80, and in step 80, CPU 36 determines whether or not the front-rear slide position acquired in step 70 is located closer to the front of the vehicle than the first reference range. When the determination in step 80 is affirmative, the seated occupant is in the attitude shown in FIG. 6F, and the seated occupant can be restrained by independently deploying the front collision AB26. Therefore, if the determination in step 80 is affirmative, the process proceeds to step 84, the preliminary process for developing only the front collision AB26 at the time of the vehicle-front collision is performed, the process proceeds to step 94.

If the determination in step 80 is negative, the process proceeds to step 82, and in step 82, CPU 36 determines whether or not the front-rear slide position is located in front of the vehicle with respect to the second reference range HP-D. When the determination in step 82 is affirmative, the seated occupant is in the attitude shown in FIG. 6D. When the determination in step 78 is negative, the seated occupant is in the position shown in FIG. 6B. In these cases, although the ceiling AB30 is suitable for restraining the seated occupant, if the ceiling AB30 is independently deployed at the time of the vehicle front collision, there is a possibility that the restraining force of the occupant is insufficient due to a large space on the vehicle front side of the ceiling AB30.

Therefore, if the determination in step 82 is affirmative, and if the determination in step 78 is negative, the process proceeds to step 90, and in step 90, CPU 36 performs a preliminary process for expanding AB in the order of (1) ceiling AB30 and (2) front collision AB26 at the time of vehicle-front collision, the process proceeds to step 94. As a result, the occupant restraint performance can be improved as compared with a case where the ceiling AB30 or the front collision AB26 is deployed alone by supporting the ceiling AB30 deployed first by the rear-deployed front collision AB26 at the time of the vehicle front-projection.

When the determination in step 82 is negative, the seated occupant is in the position shown in FIG. 6E. In this case, although the ceiling AB30 is suitable for restraining the seated occupant, if the ceiling AB30 is independently deployed at the time of the vehicle front collision, there is a possibility that the restraining force of the occupant is insufficient due to a large space in front of the vehicle on the ceiling AB30. For this reason, if the determination in step 82 is negative, the process proceeds to step 92, and in step 92, CPU 36 performs a preliminary process for expanding AB in the order of (1) the front collision AB26 and (2) the ceiling AB at the time of the vehicle front collision, and the process proceeds to step 94. As a result, the ceiling AB30 deployed backward is guided by the front collision AB26 deployed first at the time of the vehicle front collision, so that the occupant can be restrained on the ceiling AB30 at a more suitable position on the vehicle rear side. In addition, since the above-described advantages can be obtained only by controlling the expansion order of AB, it is possible to simplify the construction and reduce the cost compared with a configuration in which the expansion range of the ceiling AB30 is adjusted by the deployment direction changing ACT32.

As described above, in the second embodiment, when the seatback angle is within the first angular range -A and the front-rear slide position is located closer to the vehicle rear side than the first reference range HP-A, or when the seatback angle is within the second angular range -B and the front-rear slide position is located closer to the vehicle front side than the second reference range HP-A that is different from the first reference range HP-D, the ceiling AB30 is deployed at the time of the vehicle front collision and the front collision AB26 is deployed after the ceiling AB30, and when the seatback angle is within the second angular rang e-B and the front-rear slide position is located closer to the vehicle rear side than the second reference range HP-D or the second reference range HP-D, the front collision AB26 is deployed at the time of the vehicle front collision and the ceiling AB30 is deployed at the time of the vehicle front collision. Accordingly, when the ceiling AB30 is deployed first and the front collision AB26 is deployed backward, the occupant restraint performance can be improved as compared with a case where the ceiling AB30 or the front collision AB26 is deployed alone. Further, when the front collision AB26 is deployed ahead and the ceiling AB30 is deployed backward, the occupant can be restrained at a more suitable position of the ceiling AB30 on the rear side of the vehicle, and the construction can be simplified and cost-reduced as compared with a configuration in which the deployment area of the ceiling AB30 is adjusted.

In the second embodiment, the second reference range is set to be closer to the vehicle rear side than the first reference range. As a result, the occupant restraint performance can be further improved.

In the second embodiment described above, in step 90, a mode has been described in which AB is expanded in the order of (1) ceiling AB30 and (2) front collision AB26. However, the present disclosure is not limited thereto, and the ceiling AB30 and the front collision AB26 may be simultaneously deployed in the same step.

Further, in the above-described embodiment, an aspect has been described in which the angular range -A/-B for dividing the adjustment range of the seatback angle and the range HP-A/HP-B/HP-C for dividing the adjustment range of the front and rear slide positions are fixedly determined. However, the present disclosure is not limited thereto. For example, the physique of the seated occupant may be detected, and the range of at least one of the angle range for dividing the adjustment range of the seatback angle and the range for dividing the adjustment range of the front and rear slide positions may be changed according to the detected physique. The physique of the seated occupant can be estimated from, for example, an image of the seated occupant captured by the in-vehicle camera, a weight detected by a sensor built in the seat cushion portion of the seat 12, or a pressure distribution detected by a sensor built in the seat cushion portion and the seat back portion.

Further, in the above embodiment, the airbag control system 10A, 10B is provided in the passenger seat of the vehicle. However, the present disclosure is not limited thereto, and the airbag control system 10A, 10B may be provided in the driver's seat of the vehicle.

In the above-described embodiment, AB control program 46 is stored (installed) in the storage unit 40 in advance. However, AB control program 46 may be provided in a form recorded on a non-transitory recording medium such as a HDD, SSD, DVD.

What is claimed is:

1. A control device for a vehicle airbag, comprising a control unit that switches between deploying, among a ceiling airbag stored above an occupant seated on a seat and a front-collision airbag stored in front of the occupant, only the front-collision airbag and deploying both the ceiling airbag and the front-collision airbag when a vehicle front collision occurs, according to a front-rear slide position and a seat back angle of the seat.

2. The control device according to claim 1, wherein the control unit deploys only the front-collision airbag at a time of the vehicle front collision when the seat back angle is within a first angular range corresponding to a normal riding posture and the front-rear slide position is located within a reference range or on a vehicle front side with respect to the reference range, or when the seat back angle is within a second angular range corresponding to a comfortable posture and the front-rear slide position is located on the vehicle front side with respect to the reference range, and the control unit deploys both the ceiling airbag and the front-collision airbag at a time of the vehicle front collision when the seat back angle is within the first angular range and the front-rear slide position is located on a vehicle rear side with respect to the reference range, or when the seat back angle is within the second angular range and the front-rear slide position is located within the reference range or on the vehicle rear side with respect to the reference range.

3. The control device according to claim 2, wherein the control unit adjusts a deployment direction of the ceiling airbag using an actuator capable of changing the deployment direction.

4. The control device according to claim 3, wherein the control unit adjusts the deployment direction toward the vehicle rear side when the seat back angle is within the second angular range and the front-rear slide position is located within the reference range or on the vehicle rear side with respect to the reference range, as compared with when the seat back angle is within the first angular range and the front-rear slide position is located on the rear side with respect to the reference range.

5. The control device according to claim 2, wherein the control unit deploys the ceiling airbag and deploys the front-collision airbag simultaneously with the ceiling airbag or later than the ceiling airbag at a time of the vehicle front collision when the seat back angle is within the first angular range and the front-rear slide position is located on a vehicle rear side with respect to a first reference range, or when the seat back angle is within the second angular range and the front-rear slide position is located on the vehicle front side with respect to a second reference range different from the first reference range, and the control unit deploys the front-collision airbag first and the ceiling airbag later at a time of the vehicle front collision when the seat back angle is within the second angular range and the front-rear slide position is located within the second reference range or on the vehicle rear side with respect to the second reference range.

6. The control device according to claim 5, wherein the second reference range is set on the vehicle rear side with respect to the first reference range.
